(19) United States
(12) Patent Application Publication
(10) Pub. No.: US 2022/0385478 A1
(43) Pub. Date: Dec. 1, 2022

(54) DEPLOYING A SOFTWARE PACKAGE

(71) Applicant: Hewlett-Packard Development Company, L.P., Spring, TX (US)

(72) Inventors: Travis M Cossel, Boise, ID (US); Shane R Konsella, Boise, ID (US); Steven Livengood, Laguna Niguel, CA (US); Raghu Anantharangachar, Bangalore (IN)

(21) Appl. No.: 17/773,715

(22) PCT Filed: Jan. 15, 2020
(86) PCT No.: PCT/US2020/013702

§ 371 Date: May 2, 2022

(51) Int. Cl. H04L 9/32; G06F 8/61

(52) U.S. Cl. CPC H04L 9/3247; G06F 8/61

(57) ABSTRACT

Examples disclosed herein relate to receiving a software package deployed to a device, identifying, according to the software package, at least one feature to be provided to the device, determining whether the software package comprises a verified cryptographic signature, and in response to determining that the software package comprises the verified cryptographic signature, activating a component of the software package to provide the at least one feature to the device from an external service

### BACKGROUND

Multi-function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates).

### BRIEF DESCRIPTION OF THE DRAWINGS

FIG. 1 is a block diagram of an example computing device for deploying a software package.

FIG. 2 is a flowchart of an example method for deploying a software package.

FIG. 3 is a block diagram of an example system for deploying a software package.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Most multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

In some situations, a device such as an MFP may be configured to execute software packages that provide functionality to users of the device. For example, an MFP may include an image scanner for capturing a digital image of a physical document, while a software package may execute on the device to enable display and editing of the digital image, such as cropping and/or color correction, on a control panel of the device.

In order to deploy such a software package, an initial package may be created by a developer of the desired functionality. Such a package may comprise contents such as a solution manifest that list available features provided by the package and may comprise details on connecting to remote services to assist in providing those features. For example, the software package may provide a color correction feature for digital images and the details may comprise network address information to which the digital image may be sent for processing in order to provide that feature.

The software package may be provided to a device supplier, such as a manufacturer, a service manager, and or a seller of the device for a verification process. performed. This process allows the device supplier to inspect the software package and its manifest to ensure that only those features supported by the device are included in the package and/or that only services, such as application programming interfaces (APIs) that the software package developer should have access to are being used by the software package. Once the software package has been inspected and approved, the supplier may create a cryptographically signed version of the software package that may be provided to the developer and/or distributed to the devices directly. This signed package is unable to be modified, because doing so will invalidate the cryptographic signature. Instances of this signed package may now be deployed onto each MFP or printer that the feature is intended to operate on, even if some of the processing logic of the feature is running and/or hosted on an external or remote server, such as may be provided by the developer. During installation, the device may verify the signature of the software package to ensure its authenticity. For example, the package may be signed using a public key infrastructure in which the device supplier uses a private key to create the cryptographic signature that may be verified using a widely distributed public key.

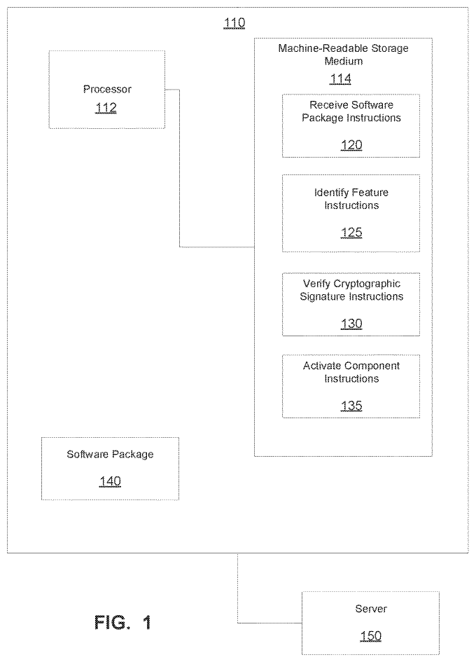

FIG. 1 is a block diagram of an example computing device 110 for deploying a software package. Computing device 110 may comprise a processor 112 and a non-transitory, machine-readable storage medium 114. Storage medium 114 may comprise a plurality of processor-executable instructions, such as instructions 120 and instructions 125. In some implementations, instructions 120, 125 may be associated with a single computing device 110 and/or may be communicatively coupled among different computing devices such as via a direct connection, bus, or network. In some implementations, a software package 140 may be received from a second computing device such as a server 150.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute receive software package instructions 120, identify feature instructions 125, verify cryptographic signature instructions 130, and activate component instructions 135.

Executable instructions 120, 125, 130, 135 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power, Nonvolatile components are those that retain data upon a loss of power.

The machine-readable storage medium 114 may comprise, for example, random access memory (RAM), read-only memory (ROM); hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other Ike memory device.

Receive software package instructions 120 may receive a software package 140 deployed to a device. For example, a software developer may prepare a package of executable code to provide additional features to a device such as device 110. Such features may be enabled by the executable code allowing data to be transmitted to and received from an external service, such as a network connected computing device and/or device(s). The external service may manipulate the data provided by the device 110 and return the manipulated data to device 110. For example, a watermarking feature may receive a scanned document digital file at the external service, identify the optimal position for the watermark and apply the watermark to the digital file at the external service, and return the watermarked document digital file to device 110.

In some implementations, the software package 140 may comprise a manifest of available features associated with the external service. The software package 140 may comprise a plurality of components each associated with an available feature. For example; a software package 140 may offer several features that may be independently activated. For example, an image processing package may offer a watermarking feature, a color correction feature, a scaling feature, an object recognition feature, etc. Each feature may be associated with a component in the software package 140 that may be cryptographically signed independently and/or the package of components may be signed as a whole. In some implementations, the software package 140 may comprise a manifest identifying which of the plurality of components are to be activated on the device 110. For example, the manifest may indicate that only the color correction feature is to be activated on device 110. If the package as a whole comprises a cryptographic signature, an attempt to modify the manifest to enable other features would change the package such that the signature would no longer be valid and none of the features from the package would be activated by the device 110.

Identify feature instructions 125 may identify, according to the software package 140, at least one feature to be provided to the device. For example, the manifest may identify a specific component and/or component(s) associated with features compatible with, available to, and/or subscribed to by device 110.

Verify cryptographic signature instructions 130 may determine whether the software package 140 comprises a verified cryptographic signature. For example, device 110 may have a copy of a public key associated with a supplier of the device. The package may be signed using a public key infrastructure in which the device supplier uses a private key to create the cryptographic signature that may be verified using the public key. In some implementations, the verified cryptographic signature may be associated with a supplier of the device, such as a manufacturer of the device, a manager of the device, and a seller of the device.

Activate component instructions 135 may in response to determining that the software package 140 comprises the verified cryptographic signature, activate a component of the software package 140 to provide the at least one feature to the device from an external service. For example, device 110 may enable the software package 140 to interact with services and functionality on device 110 (e.g., making API calls, using hardware and software resources, etc.) in order to provide the at least one feature.

In some implementations, the component may comprise executable logic for communicating with the external service. For example, the component may provide a first set of data associated with the device to the external service and/or receive a second set of data from the external service. Such a second set of data may comprise, for example, a result of a manipulation of the first set of data performed by the external service associated with the at least one feature.

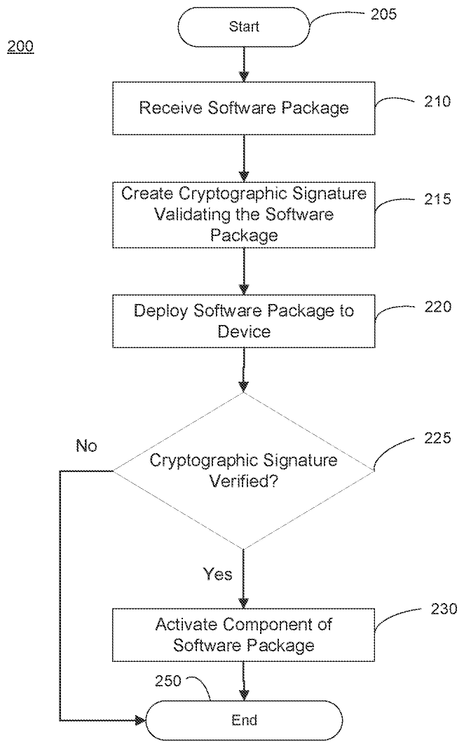

FIG. 2 is a flowchart of an example method 200 for consumable characteristic identification. Although execution of method 200 is described below with reference to computing device 110 and server 150, other suitable components for execution of method 200 may be used.

Method 200 may begin at stage 205 and advance to stage 210 where server 150 may receive a software package 140 from a developer of the software package 140. In some implementations, server 150 may be associated with a supplier of computing device 110. For example, a software developer may prepare a package of executable code to provide additional features to a device such as device 110. Such features may be enabled by the executable code allowing data to be transmitted to and received from an external service, such as a network connected computing device and/or device(s). The external service may manipulate the data provided by the device 110 and return the manipulated data to device 110. For example, a watermarking feature may receive a scanned document digital file at the external service, identify the optimal position for the watermark and apply the watermark to the digital file at the external service, and return the watermarked document digital file to device 110.

In some implementations, the software package 140 comprises a plurality of components each associated with an available feature. For example, a software package 140 may offer several features that may be independently activated. For example, an image processing package may offer a watermarking feature, a color correction feature, a scaling feature, an object recognition feature, etc, Each feature may be associated with a component in the software package 140 that may be cryptographically signed independently and/or the package of components may be signed as a whole. In some implementations, the software package 140 may comprise a manifest identifying which of the plurality of components are to be activated on the device 110. For example, the manifest may indicate that only the color correction feature is to be activated on device 110. If the package as a whole comprises a cryptographic signature, an attempt to modify the manifest to enable other features would change the package such that the signature would no longer be valid and none of the features from the package would be activated by the device 110.

Method 200 may then advance to stage 215 where server 150 may create a cryptographic signature validating the software package 140 for deployment to the device 110. For example, the supplier of device 110 may use a private key to create a cryptographic signature for the software package 140 based on, for example, a checksum of the package. This signature may be appended to and/or distributed with the software package 140.

Method 200 may then advance to stage 220 where server 150 may deploy the software package 140 to the device 110. For example, the software package 140 may be transmitted via a network and/or copied from a media such as a USB-based memory device to the device 110.

Method 200 may then advance to stage 225 where server 150 may verify the cryptographic signature of the software package 140 for the device 110. For example, device 110 may determine whether the software package 140 comprises a verified cryptographic signature. For example, device 110 may have a copy of a public key associated with a supplier of the device. The package may be signed using a public key infrastructure in which the device supplier uses a private key to create the cryptographic signature that may be verified using the public key. In some implementations, the verified cryptographic signature may be associated with a supplier of the device, such as a manufacturer of the device, a manager of the device, and a seller of the device.

Method 200 may then, in response to verifying the cryptographic signature of the software package 140, advance to stage 230 where server 150 may cause the device activate a component of the software package 140 to provide a feature to the device from an external service associated with the developer of the software package 140. For example, server 150 may enable communication with the device 110 in order to exchange data to perform the desired feature.

In some implementations, causing the device 110 to activate the component may comprise enabling the component to exchange data associated with the feature between the device 110 and the external service.

After the component is activated at stage 230, or if the cryptographic signature is not verified at stage 225, method 200 may then end at stage 250.

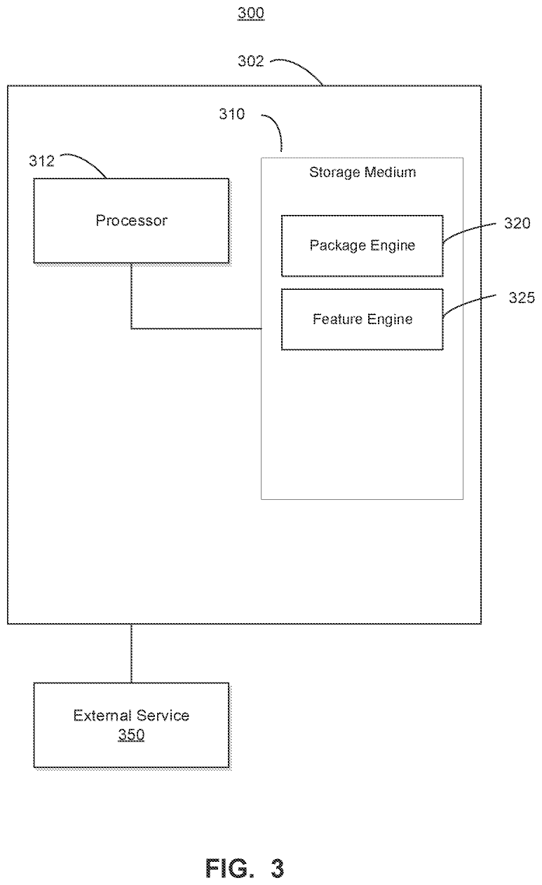

FIG. 3 is a block diagram of an example apparatus 300 for deploying a software package 140. Apparatus 300 may comprise a multi-function printer device 302 comprising a storage medium 310, and a processor 312. Device 302 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 302 may store, in storage medium 310, a package engine 320 and a feature engine 325.

Each of engines 320, 325 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325. In such examples, device 302 may comprise the machine-readable storage medium storing the instructions and the processing resource to execute the instructions, or the machine-readable storage medium may be separate but accessible to apparatus 300 and the processing resource.

Package engine 320 may receive a software package 140 deployed to a device, such as device 110, and determine whether the software package 140 comprises a verified cryptographic signature.

Feature engine 325 may identify, according to the software package 140, at least one feature to be provided to the device 110, and, in response to determining that the software package 140 comprises the verified cryptographic signature, activate a component of the software package 140 to provide the at least one feature to the device 110 from an external service 350.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed:

1. A non-transitory machine-readable medium storing instructions executable by a processor to:
receive a software package deployed to a device;
identify, according to the software package, at least one feature to be provided to the device;
determine whether the software package comprises a verified cryptographic signature; and
in response to determining that the software package comprises the verified cryptographic signature, activate a component of the software package to provide the at least one feature to the device from an external service.

2. The non-transitory machine-readable medium of claim 1, wherein the software package comprises a manifest of available features associated with the external service.

3. The non-transitory machine-readable medium of claim 1, wherein the component comprises executable logic for communicating with the external service.

4. The non-transitory machine-readable medium of claim 3, wherein the component provides a first set of data associated with the device to the external service.

5. The non-transitory machine-readable medium of claim 4, wherein the component receives a second set of data from the external service.

6. The non-transitory machine-readable medium of claim 5, wherein the second set of data comprises a result of a manipulation of the first set of data performed by the external service associated with the at least one feature.

7. The non-transitory machine-readable medium of claim 1, wherein the verified cryptographic signature is associated with a supplier of the device.

8. The non-transitory machine-readable medium of claim 7, wherein the supplier of the device comprises at least one of the following: a manufacturer of the device, a manager of the device, and a seller of the device.

9. The non-transitory machine-readable medium of claim 7, wherein the manifest is not provided by the supplier of the device.

10. A method comprising:
receiving, by a supplier of a device, a software package from a developer of the software package;
creating, by the supplier of the device, a cryptographic signature validating the software package for deployment to the device;
deploying the software package deployed to the device;
verifying the cryptographic signature of the software package for the device; and
in response to verifying the cryptographic signature of the software package, causing the device activate a component of the software package to provide a feature to the device from an external service associated with the developer of the software package.

11. The method of claim 10, wherein causing the device to activate the component comprises enabling the component to exchange data associated with the feature between the device and the external service.

12. The method of claim 10, wherein the software package comprises a plurality of components each associated with an available feature.

13. The method of claim 12, wherein the software package comprises a manifest identifying which of the plurality of components are to be activated on the device.

14. A system, comprising:
a package engine to:
receive a software package deployed to a device, and
determine whether the software package comprises a verified cryptographic signature; and
a feature engine to:
identify, according to the software package, at least one feature to be provided to the device,
in response to determining that the software package comprises the verified cryptographic signature, activate a component of the software package to provide the at least one feature to the device from an external service.

15. The system of claim 14, wherein activating the component comprises enabling the component to exchange data associated with the feature between the device and the external service.
